(19) United States
(12) Patent Application Publication
(10) Pub. No.: US 2026/0009191 A1
(43) Pub. Date: Jan. 8, 2026

(54) RECTANGULAR SCRAPER

(71) Applicants: MOHAMED A. HASSAN, STEPHENS CITY, VA (US); AHMED M. HASSAN, MINNEAPOLIS, MN (US)

(72) Inventors: MOHAMED A. HASSAN, STEPHENS CITY, VA (US); AHMED M. HASSAN, MINNEAPOLIS, MN (US)

(21) Appl. No.: 19/263,013

(22) Filed: Jul. 8, 2025

Related U.S. Application Data
(63) Continuation-in-part of application No. 29/894,368, filed on Jun. 8, 2023, now Pat. No. D1083267.

(51) Int. Cl. E01C 19/44; B25G 3/12; E01C 23/082

(52) U.S. Cl. CPC E01C 19/44; B25G 3/12; E01C 23/082

(57) ABSTRACT

A concrete scraper has a rectangular shaped sheet metal body attached to an elongated handle. The rectangular shaped body has a top edge configured to scrape and finish concrete. Concrete grabbing steel wires extend downwardly from the front of the body opposite the top edge of the body. Users have the option of rotating the scraper to scrape concrete with or without the steel wires.

### CROSS REFERENCE TO RELATED APPLICATION

This application is a continuation-in-part of U.S. application Ser. No. 29/894,368, filed Jun. 8, 2023.

### FIELD OF INVENTION

The invention is in the art relating to manually operated concrete tools and implements for scraping, cleaning, working and finishing concrete used in the construction industry.

### BACKGROUND OF THE INVENTION

Tools for scraping, cleaning and finishing freshly mixed concrete are common. Concrete finishing is essential to most building construction projects. Once concrete is poured, it requires smoothing to achieve a finished concrete surface that is substantially flat to facilitate building on the concrete surface and driving thereon. The application of certain flowable materials such as concrete is environmentally hazardous and a physically demanding task. Once a concrete mixture is poured into an area defined by a form or the like, the concrete can be screeded. Screeding typically involves taking a board, a hand trowel or other items having a flat edge and swiping it across the surface of the concrete with a back and forth motion in order to push excess concrete, fill voids in the pour area and obtain a desired evenness of a surface. Concrete workers doing the screeding are usually on their knees, drag large boards across the pour area and have a need for a lightweight tool used to enhance production with less physical exertion while performing finishing tasks. Mitigation of concrete loss and elimination of exposure of hazardous debris is necessary. Further, a substantially smooth surface may not be desirable in some applications where some texture to the concrete is needed for vehicle or pedestrian traction. Commonly, a broom or brush is used to provide a desired texture to the concrete after the concrete has been screeded.

### SUMMARY OF THE INVENTION

The rectangular scraper of the invention has a rectangular shaped body having a front wall, back wall and sides walls defining an open top and open bottom. A plurality of braided steel wires extending downwardly from the front wall of the rectangular shaped body are used to grab, scrap and finish concrete. A wire clamp connected to the front wall of the body accommodates and securely holds the braided steel wires to the front wall. An elongated handle attached to the rectangular shaped body is used to manipulate and rotate the body to scrape concrete with or without the steel wires.

### DESCRIPTION OF THE DRAWING

FIG. 1 is a perspective view of a rectangular scraper;

FIG. 2 is a top plan view of the rectangular scraper of FIG. 1;

FIG. 3 is a sectional view taken along line 3-3 of FIG. 2;

FIG. 4 is an enlarged front elevational view of the rectangular scraper of FIG. 1; and

FIG. 5 is an enlarged rear elevational view of the rectangular scraper of FIG. 1.

### DETAILED DESCRIPTION

In the following detailed descriptions of the rectangular scraper, reference is made to the accompanying drawing that form a part hereof, and in which are shown, by way of illustration, specific embodiments in which the invention may be practiced. It is to be understood that other embodiments may be utilized and structure changes may be made or other method steps and sequence thereof may be used without departing from the scope of the present invention. The rectangular scraper is herein described as used in cement construction environments. The rectangular scraper can have uses in other environments when scraping, cleaning and finishing of flowable material is desired.

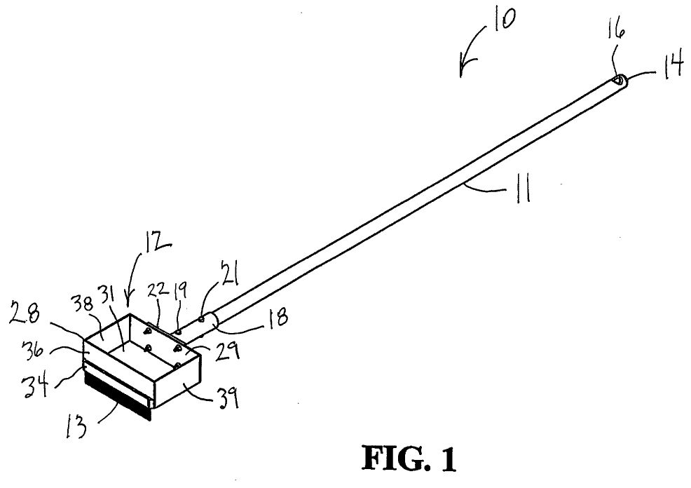

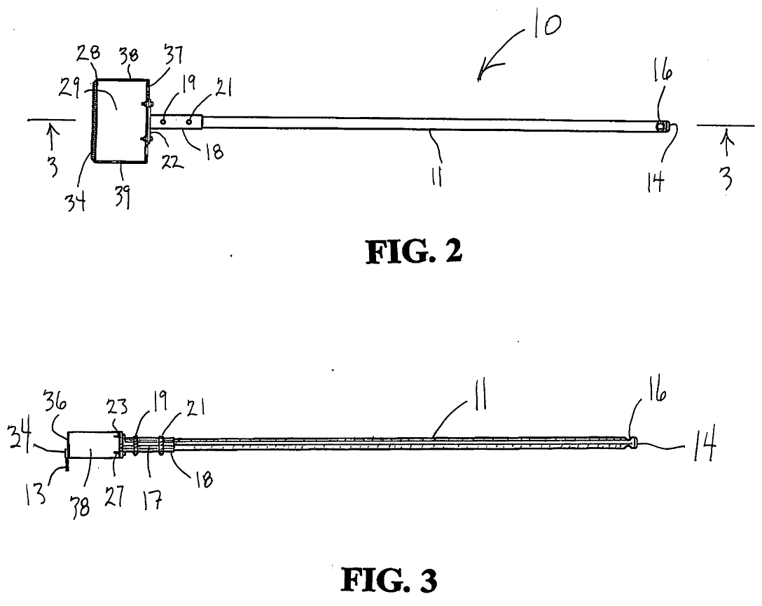

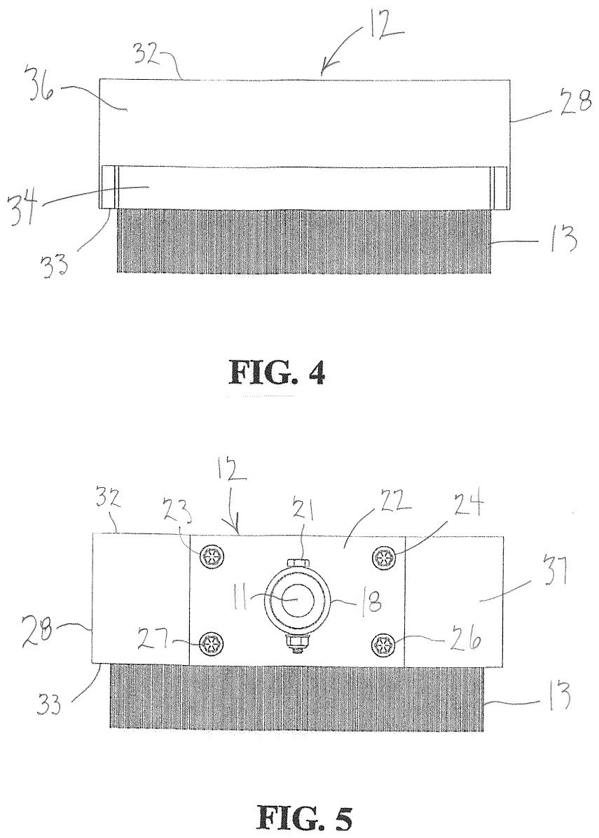

Referring to FIGS. 1 to 7, there is shown a rectangular scraper indicated generally at 10. Rectangular scraper 10 is a mechanical tool controlled with human effort used for working and finishing poured concrete and cleaning up concrete residue spills. Scraper 10 includes two main sub-assemblies, namely, an elongated hollow cylindrical rod or handle 11 and a rectangular sheet plate head 12 having downwardly extending steel braided wires 13 attached thereto. Handle 11 is preferably made of tubular steel. Other materials, such as plastic or wood, can be used to make handle 11. End 14 of handle 11 has an opening 16 to facilitate hanging and storage of scraper 10. Handle 11 is also configured for mounting on the fender side of a concrete agitator truck. End 17 of handle 11 opposite from end 14 telescopes into and is connected to the outer tubular end of a coupler 18. Fasteners 19 and 21 extending through end 17 and coupler 18 connect end 17 of handle 11 to coupler 18. End 17 can also be threaded and coupler 18 can have threading to accommodate the threaded end of rod 11. The inner end of coupler 18 has a substantially flat transverse plate or brace 22. Brace 22 is a steel plate configured to be connected to rectangular head 12 with fasteners 23, 24, 26 and 27. Brace 22 and rectangular head 12 each have aligned holes to accommodated fasteners 23, 24, 26 and 27 for connecting brace 22 and head 12 together. Brace 22 can also be welded to head 12 to connect brace 22 to head 12.

Rectangular head 12 has a rectangular shaped body 28 having a front wall 36, back wall 37 and side walls 38 and 39 defining an open top 29 and an open bottom 31 opposite open top 29. Top edge 32 of rectangular body 28 extends outwardly and upwardly from handle 11. Top edge 32 of rectangular body 28 is coplanar with bottom edge 33 of body 28. Bottom edge 33 extends outwardly and downwardly from handle 11 opposite top edge 32.

Wires 13 are each preferably made of closely grouped braided steel wire having approximately 150 rounds of braided steel. Wires 13 are sufficiently hard and stiff enough to absorb forces applied from a worker, such as to scrape wet or dried concrete. A wire clamp 34 connected to front wall 36 of rectangular body 28 accommodates wires 13 and fastens wires 13 to body 28. Wire clamp 32 is welded to front wall 36 of body 28. Fasteners (not shown) can also be used to connect wire clamp 32 to front wall 36 of body 28. The lower ends of wires 13 extend downwardly from body 28 and adjacent to bottom edge 33 to facilitate scraping concrete.

In use, when concrete is poured and the side chute of the cement agitator truck travels and spills concrete reside, the motion of rectangular scraper 10 can be applied to the spillage by workers to maintain a high level of cleaning assurance. Rectangular scraper 10 allows from pulling, pushing and rotation to be applied to scrape and work concrete. Top edge 32 of rectangular body 28 is used to scrape and move concrete from a surface. Planer top edge 32 of body 28 increases the amount of surface contact applied to the surface being scraped. Rectangular scraper 10 can be rotated whereby closely grouped steel braided wires 13 can be applied so as to scrape and finish concrete. Wires 13 grab concrete to mitigate concrete loss and eliminate exposure of hazardous debris to domestic areas and edges. The bi-directional scraping ability of rectangular scraper 10 provides users with the option to scrape various types of surfaces with or without wire 13.

The foregoing drawing and description of the rectangular scraper is one embodiment of the invention. Persons skilled in the art of scrapers for concrete can make changes and modifications of the structures and materials to the rectangular scraper without departing from the rectangular scraper and method of scraping defined in the claims.

1. A rectangular scraper comprising:
a rectangular shaped body having a front wall and a back wall joined to side walls defining an open top and an open bottom opposite the open top,
a plurality of braided steel wires extending downwardly from the front wall of the rectangular shaped body,
a wire clamp connected to the front wall of the rectangular shaped body,
the wire clamp accommodating and fastening the plurality of braided steel wires to the front wall,
an elongated handle, and
a coupler fastened to the back wall of the rectangular shaped body,
the coupler accommodating and fastening the elongated handle to the rectangular shaped body.

2. The rectangular scraper of claim 1 wherein:
the front wall, the back wall and the side walls of the rectangular body are sheet plate walls.

3. The rectangular scraper of claim 1 wherein:
the rectangular body has a top edge and a bottom edge coplanar with the top edge.

4. The rectangular scraper of claim 1 wherein:
the front wall has a top edge located opposite from the plurality of braided steel wires.

5. The rectangular scraper of claim 1 wherein:
the coupler has a transverse plate connected to the back wall of the rectangular shaped body to connect the coupler to the rectangular shaped body.

6. The rectangular scraper of claim 1 wherein:
the coupler has an outer tubular end,
the elongated handle having an end telescoping into the outer tubular end, and
fasteners extending through the outer tubular end and the end of the elongated handle to fasten the end of the elongated handle to the outer tubular end.

7. The rectangular scraper of claim 1 including:
fasteners extending through the coupler and the back wall of the rectangular shaped body to connect the coupler to the rectangular shaped body.

8. A method of scraping wet or dry concrete comprising:
providing a rectangular shaped body having upright walls defining an open top and an open bottom opposite from the open top,
providing one of the upright walls with a top edge,
providing the rectangular shaped body with a plurality of steel wires configured to grab concrete,
fastening the plurality of steel wires to the rectangular shaped body whereby the plurality of steel wires extend opposite the top edge, and
selectively rotating the rectangular shaped body to scrape the concrete with either the top edge or the plurality of steel wires.

9. The method of claim 8 including:
connecting an elongated handle to the rectangular shaped body, and
rotating the elongated handle to selectively rotate the rectangular shaped body.

10. The method of claim 8 including:
providing a coupler to accommodate the elongated handle, and
fastening the coupler to the rectangular shaped body.

11. The method of claim 8 wherein:
the top edge of is a planer top edge.

12. The method of claim 8 wherein:
the plurality of steel wires are braided steel wires.
